(19) United States
(12) Patent Application Publication
(10) Pub. No.: US 2012/0009104 A1
(43) Pub. Date: Jan. 12, 2012

(54) Smart Test Tube Rack

(76) Inventors: Eugene Leonidovich Bolotin, Berkeley, CA (US); Jashua Lee Halford, Riverside, CA (US)

(21) Appl. No.: 13/176,056

(22) Filed: Jul. 5, 2011

Related U.S. Application Data
(60) Provisional application No. 61/361,922, filed on Jul. 7, 2010.

(51) Int. Cl. B01L 9/06

(52) U.S. Cl. 422/562

(57) ABSTRACT

Improvements in a test tube rack are presented. The test tube rack has a main body with a plurality of test tube insertion holes. A switch is placed on the bottom of every hole and the switch is triggered upon insertion of the tube and upon depressing the test tube within the rack. A counting circuit is connected to a readout device, such as light source or a display. When the test tube rack is connected to a power source the readout device displays the number of times the switch that is associated with each test tube was pressed. The smart test tube rack allows an operator to track which test tube where chemicals have been added. The readout can include multiple colors to track the inclusion of multiple chemicals by counting or changing colors.

### CROSS REFERENCE TO RELATED APPLICATION

This application claims the benefit of Provisional Application Ser. No. 61/361,922 filed Jul. 7, 2010 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in a test tube rack. More particularly, the present smart test tube rack helps the researcher or user in the methodical application of chemicals in the order they wish to add them by turning on a specifically colored Light Emitting Diode (LED) after each application of a chemical, to assist in the user in knowing which chemical they have just added.

2. Description of Related Art Including Information Disclosed Under 37 CFR 1.97 and 1.98

Laboratory researchers commonly use test tube racks. Such racks are made of various materials such as plastic or metal and are used to hold test tubes of various sizes for the ease of pipetting liquid chemicals. An average rack can hold 18 to 36 test tubes, and since a user can add 3 or more chemicals sequentially to each tube, tracking each chemical becomes a challenge; frequent mistakes are made wasting valuable time and reagents. Therefore, a need for some sort of systematic way to assist a researcher in keeping track of multi-chemical reaction throughout its preparation.

A regular test tube rack is a rectangular plate at least 3 cm thick with 1 cm diameter wells, which are ˜3 cm deep spaced ˜1 cm apart. It is designed to hold standard 0.5 ml, 1.5 ml, or 2 ml tubes, but can accommodate any size of tube. Many other “non-standard” sizes exist; regardless the test tube rack is defined by its ability to hold any number of test tubes of any shape in any orientation.

One method in keeping track of chemicals is simple memorization which is prone to error and susceptible to distraction. The other is writing the reagent name on the tube itself or on a notebook, a time consuming and error prone task. Additionally, moving tubes after adding a chemical is another way to track chemicals; however this severely limits the capacity of the rack and becomes time consuming and error prone with larger number of tubes. Thus there is a need to simplify keeping track of multiple chemicals to minimize errors, labor, time and cost.

When pipetting chemicals into a rack of test tubes it is often difficult to keep track of the test tubes where chemicals have been added. This is particularly difficult if in the process of pipetting a person's distracted by a co-worker or a phone call. While there are many patented test tube racks in production, there are none that use a multicolored LED in order to facilitate in the proper procedure of chemical application to each individual test tube. Exemplary examples of patents covering these products are disclosed herein.

U.S. Patent Publication Number 2005/0180895 that published on Aug. 18, 2005 to Teruaki Itoh discloses a test tube rack. One of the unique properties of this rack is that the slots for the tube have a flexible retainer to prevent the sides of each test tube from rattling in the holder. While this publication discloses a test tube rack, the test tube rack does not provide any indication regarding what tubes chemicals have been added.

U.S. Patent Publication Number 2009/0238727 that was published on Sep. 24, 2009 and U.S. Pat. No. 7,553,671 that issued on Jun. 30, 2009 were both for James E. Sinclair et al., disclose a modular test tube rack where multiple modular racks of test tubes can be added to increase or decrease the number of test tubes that can be transported or handled at a time. While these references disclose test tube racks they do not disclose an indicating system to identify the processing on one or more of the test tubes.

U.S. Pat. Nos. 6,416,198, 6,824,289, 7,063,432 and 7,401,935 issued on Jul. 9, 2002, Nov. 30, 2004, Jun. 20, 2006 and Jul. 22, 2008 respectively all to Carl R. VanderSchuit disclose a beverage accessory device that is essentially a simulated ice cube that illuminates different colors. While this patent discloses illumination using LED's, the illumination is a preset pattern and does not illuminate when a test chemicals have been added to a test tube.

A need exists to assist the researcher in remembering which chemical they have just added to which test tube. The proposed application provides a solution to this problem by providing a sensor with a visual indicator to identify the tubes that need to be pipetted or have been pipetted.

### BRIEF SUMMARY OF THE INVENTION

It is an object of the smart test tube rack to improve on using the standard rack, but improving the tracking of chemicals added by use of a display, preferably multicolored LEDs that light up in a sequence after each application by the user comprising smart test tube rack, alternately a small liquid crystal display could be used.

It is an object of the smart test tube rack to comprise a test tube rack of any shape or size with the following additions. The rack includes an electromechanical switch at the bottom of each well, although this can be replaced by a weight sensing switch in other embodiments. The switch is which is connected to a multicolor light emitting diode (LEDs), but those skilled in art can recognize that any light source can be used. The switch is connected to an LED in the same well through a circuit, preferably an integrated printed circuit. As the test tube is added to the rack well the switch would offer mechanical resistance such that only additional pressure on the test tube pressed would trigger LEDs. Additional pressure, which could be applied by adding a chemical to the tube trigger the switch. Upon triggering the switch the integrated circuit would enable the LEDs to change colors.

It is also an object of the smart test tube rack for presses of the switch to activate the LED light and keep the LED light in an ON condition. Pressing the switch again will change the LED to a different colors, the LED will stay on and illuminate the tube, marking the position and chemical added. The user can repeat the process as the LED will change color each time, each time staying “ON”. LED can change color to as many primary colors as possible. 8 different colors are easily achievable and would enable the user to keep track of 9 different chemicals 8+1 (non-illuminated). The switch could be activated by the bottom of the 1.5 ml tube hitting the mechanical switch, it could be pressing on the tube by hand, or by using the pipette inserted into the tube, thus reducing the amount of motions required to press the tube. Thus the user would be able to track the chemical addition steps through color changing of each well through each subsequent step.

It is still another object of the smart test tube rack for the display to be one or more liquid crystal display(s), but any small display could be used. The display would be located next to the test tube and could display any numeral representing the number of times the switch was pressed, allowing the researchers to keep track of any number of chemicals added.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 is a top side view of the test tube rack.

FIG. 2 is a cross-sectioned cut-away side view of the test tube rack.

FIG. 3 is a cross-sectioned blown-up view of an individual slot in the test tube rack with a test tube with an integrated circuit underneath.

FIG. 4 is a cross-sectioned blown-up view of an individual slot in the test tube rack with a test tube with an integrated circuit underneath.

FIG. 5 is a cross-sectioned blown-up view of an individual slot in the test tube rack with a test tube with an integrated circuit underneath.

FIG. 6 is a cross-sectioned blown-up view of an individual slot in the test tube rack with a test tube with an integrated circuit underneath.

### DETAILED DESCRIPTION OF THE INVENTION

In first preferred embodiment the test tube rack does not outwardly differ significantly from a standard rack. The differences between a simple rack and the first preferred embodiment become apparent as shown in the following figures.

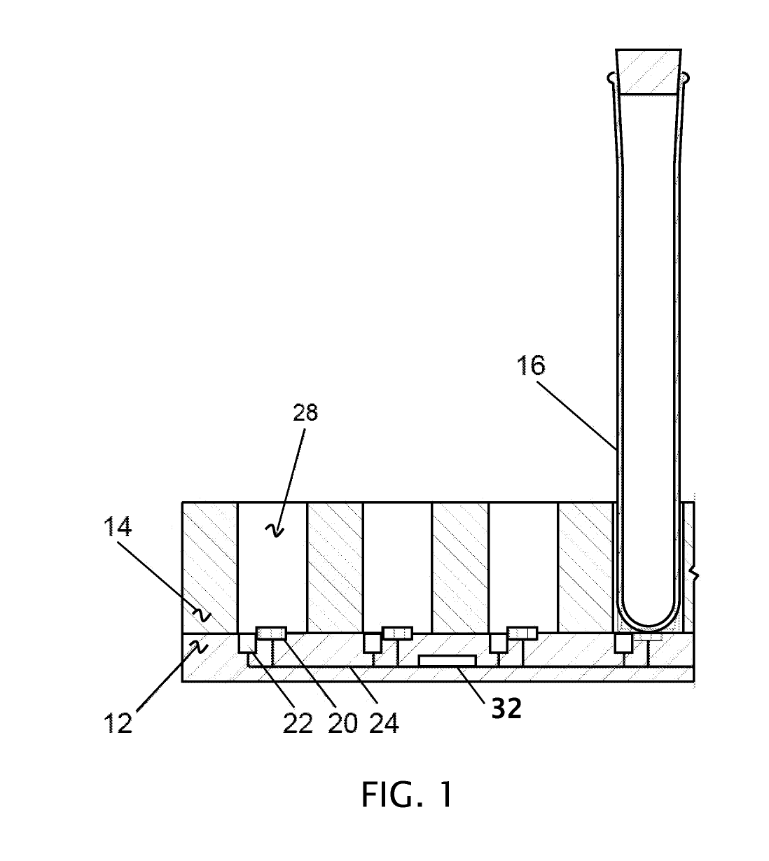

FIG. 1 is a top side view of the test tube rack. The rack 14 has a rack base 12, with a plurality of holes or wells 28 in which test tubes 16 can be inserted. FIG. 1 further illustrates the test tube 16 inserted into well(s) 28 where the test tube depresses the switch 20. The test tube 16 rests on a switch 20. The switch 20 is preferably a momentary electromechanical switch. It must be understood that other types of momentary switches can be used including but not limited to, dome push switch, a membrane switch, motion-responsive switch, a force sensing, temperature-sensitive switch, voice activated switch or wireless command using RF, IR would suffice.

The test tube may be a tube of any size that is suitable to fit into the well(s) 28. Additionally, the rack 14 may accommodate connected tubes such as strips or plates as long as their dimensions correspond to the size and spacing of the holes 28. It is further contemplated that the top portion of the rack 14 can be removed from the rack base 12 to provide for cleaning as well as the ability to change the top portion of the rack 14 to accommodate test tubes with different diameters while still maintaining only a single “intelligent” back base.

The switch 20 is attached to a circuit 24 using a wire 32 which controls the light source 22. In one preferred embodiment, upon activation of switch 20, the control circuit or micro-controller 32 toggles the light source 22 from “on” to “off” or from “off” to “on”. In more advanced embodiments, the circuit 24 illuminates other light emitting elements to produce colors or color variations or shades from one state to another, in color spectrum. In this embodiment, upon multiple pressing of the switch 20 the circuit 24 would direct the light source 22 to transition from one color, to another and so forth, thus acting as a primitive display to supplement user's memory of the number of times the switch was pressed when additional chemicals are added to each individual test tube.

The circuit 24 is preferably an integrated printed circuit, but those skilled in the art will recognize, that any circuit capable of changing the LED display could be used. The light source 22 can be any source that can illuminate the test tube rack and preferably the test tube 16 as well. Any light source 22 suited for the purpose will suffice, such as but not limited to light-emitting diodes (LEDs), fiber optics, halogen, incandescent, laser, fluorescent, neon, black light, magnetic and the like. It is preferred, however that the light source 22 does not impart excessive or undesired heat or temperature to the test tubes. An LED is preferred, however, those skilled in the art will recognize that any light source mechanism suited for intended purposes may be employed and are not limited to these forms of light source mechanisms described above.

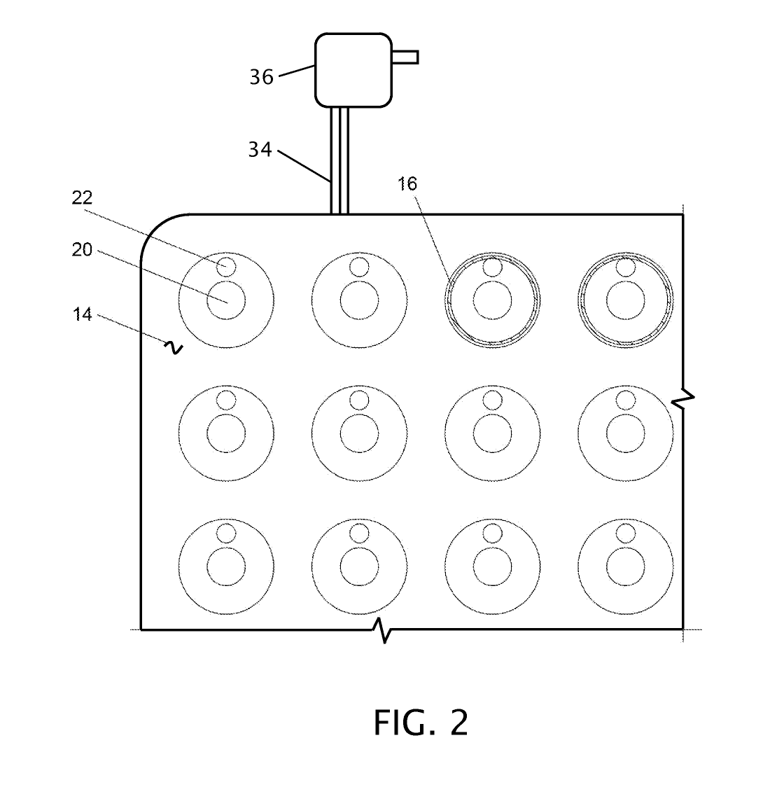

FIG. 2 is a cross-sectioned cut-away side view of the test tube rack 14. FIG. 2 illustrates the top down view of the embodiment with the relative positions of transparent test tube 16, switch 20 and light source 22 on the rack 14. A transformer 36 connects 34 to the test tube rack to provide power to the test tube rack or to rechargeable batteries.

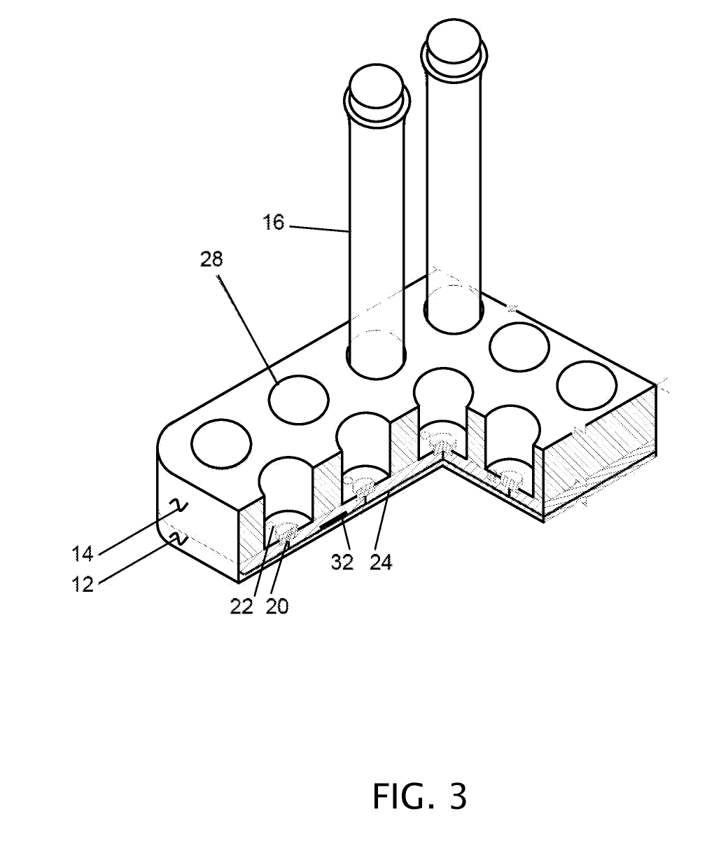

FIG. 3 is a cross-sectioned blown-up view of an individual slot in the test tube rack with a test tube in it, with integrated circuit underneath. FIG. 3 further illustrates the embodiment with isometric, cut-away view. In FIG. 3 the rack 14 is shown holding a test tube 16 in a well 28. The rack base 12 has supports the circuit 24 board with the switch 20 and the light source 22.

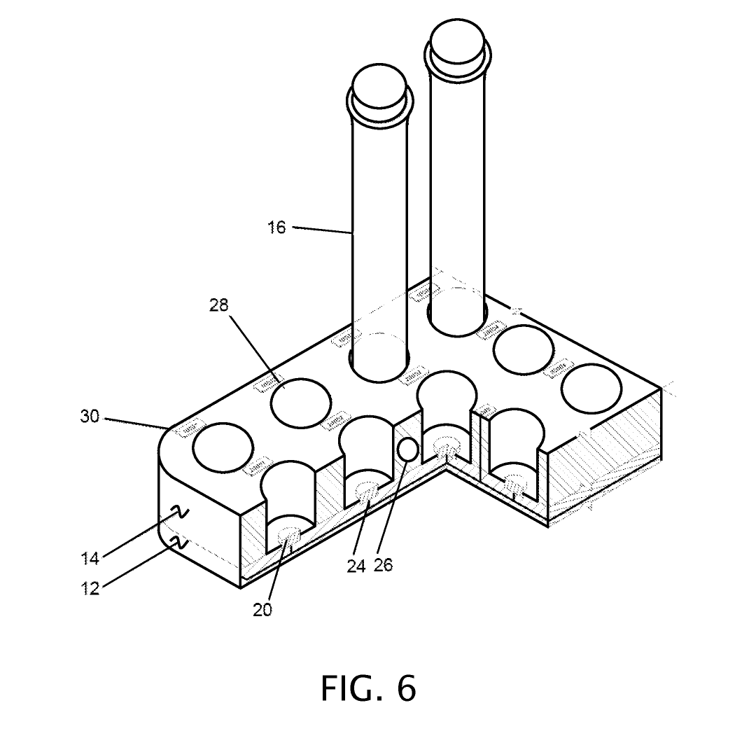

Additionally, the power source 36, as shown in FIG. 2 contemplates any means of providing energy to the microcontroller 32, light source 22 and the circuit 24. Any power source suited for the intended purpose would suffice, including but not limited to, batteries 26, as shown in FIG. 6, of any kind, and any power from electric grid. The rechargeable power source could be rechargeable by any means including but not limited to solar, magnetic, electrical and other means. Those skilled in the art will recognize, however, that any power source mechanism suited for the task may be employed.

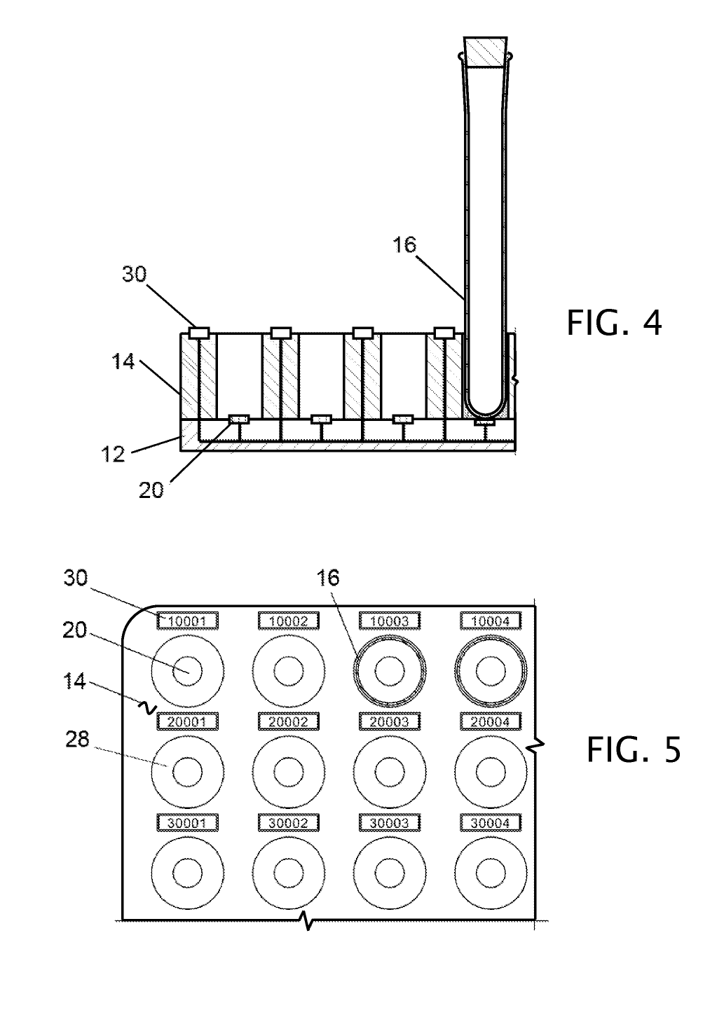

An alternate embodiment illustrated in FIGS. 4, 5, and 6 it is identical to the one illustrated in FIGS. 1, 2 and 3, except it uses a character, matrix or graphical display 30 to visualize the number of button presses. The display would enumerate the number of button presses to assist the user. The display may also display any other helpful information such as time or date etc. While any display of sufficiently small size could be used, segmented crystal display would be preferred. The display 30 can be an incremental or a decrement indicator or counter.

Thus, specific embodiments of a smart test tube rack have been disclosed. It should be apparent, however, to those skilled in the art that many more modifications besides those described are possible without departing from the inventive concepts herein. The inventive subject matter, therefore, is not to be restricted except in the spirit of the appended claims.

1. A smart test tube rack comprising:
a sample holder containing at least two holes for test tubes;
at least one switch at a base or adjacent to each of said at least two holes which is depressible;
at least one display that indicates that said at least one switch was depressed, and
at least one power source that powers said at least one display, with an off mode and an on mode.

2. The smart test tube rack according to claim 1 wherein said display consists of at least one segmented liquid crystal segmented display.

3. The smart test tube rack according to claim 1 wherein said display consists of at least one light emitting device, with at least one distinct color.

4. The smart test tube rack according to claim 1 wherein said display consists of at least one light multi-color light emitting diode.

5. The smart test tube rack according to claim 4 wherein said at least one light multi-color light emitting diode changes color when said at least one switch is depressed.

6. The smart test tube rack according to claim 1 wherein said display consists of at least one liquid crystal display.

7. The smart test tube rack according to claim 1 wherein said sample holder is separable and changeable from said base.

8. The smart test tube rack according to claim 1 wherein said display consists of at least character light emitting diode display.

9. The smart test tube rack according to claim 1 wherein said display consists of at least one graphical liquid crystal display.

10. The smart test tube rack according to claim 1 that further includes rechargeable batteries.

11. The smart test tube rack according to claim 1 wherein said at least one switch is selected from a group consisting of at least one of a dome push switch, a membrane switch, a motion-responsive switch, wireless switch and a temperature-sensitive switch.

12. The smart test tube rack according to claim 1 wherein said at least one switch is a force sensing resistor.

13. The smart test tube rack according to claim 12 wherein said force sensing resistor signals a switch depression when a chemical is dispensed inside a test tube within at least one of said at least two holes by detecting a change in resistance

14. The smart test tube rack according to claim 12 wherein said force sensing resistor further determines the presence and absence of at least one test tube placed within at least one of said at least two holes.

15. The smart test tube rack according to claim 1 that further includes a microcontroller.

16. The smart test tube rack according to claim 1 wherein said at least one display identifies that said at least one switch has been depressed.

17. The smart test tube rack according to claim 1 wherein said at least one display identifies that said at least one switch has not been depressed.

18. The smart test tube rack according to claim 1 wherein said at least one display illuminates at least one test tube placed within one of said at least two holes.

19. The smart test tube rack according to claim 1 wherein said at least one display is and incremental indicator.

20. The smart test tube rack according to claim 1 wherein said at least one display is a decremented indictor.
